(19) United States
(12) Patent Application Publication
(10) Pub. No.: US 2007/0125609 A1
(43) Pub. Date: Jun. 7, 2007

(54) Transmission damping apparatus and method

(76) Inventors: Michael F. O'Leary, Howell, MI (US); Jeffrey S. Rayce, Royal Oak, MI (US); David A. Gilbert, Royal Oak, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/296,694

(22) Filed: Dec. 7, 2005

(51) Int. Cl. F16F 9/53

(52) U.S. Cl. 188/267.1

(57) ABSTRACT

The present invention provides a damping apparatus and/or method for a rotatable shaft. The damping apparatus includes a damper housing disposed about a portion of the rotatable shaft. A variable viscosity fluid, such as a magneto-rheological fluid, is disposed within the damper housing and in contact with the rotatable shaft. A control device is operatively connected with respect to the variable viscosity fluid. The control device is configured or operable to control the viscosity of the variable viscosity fluid and correspondingly control the amount of rotational resistance applied to the rotatable shaft.

### TECHNICAL FIELD

The present invention pertains generally to an improved damping apparatus and a method for damping a rotatable shaft.

### BACKGROUND OF THE INVENTION

Intermeshing gears may sometimes produce a noise or gear rattle during transient relative rotational speed changes between a drive and a driven gear. One example where this may occur is within a manual shift or countershaft transmission. A countershaft transmission has an input shaft, a countershaft, and an output shaft. The input shaft and the countershaft are interconnected by meshing gears (head gear set). The countershaft and the output shaft are interconnected by a plurality of meshing gears (speed gears) that are selectively connectible to one of the shafts through synchronizer clutch arrangements. Thus, a plurality of gear meshes are present between the input shaft and the output shaft. The speed ratio between the input shaft and the output shaft is controlled by the meshing speed gears. The speed ratio between the input shaft and the output shaft is changed by interchanging the synchronizers that control the connection of the speed gears to their respective shafts. The head gear set and the active speed gear set have a lash condition. Under some operating conditions, the lash condition of the head gear set and the active speed gear set can reverse possibly resulting in a gear rattle caused by the lash reversal.

Gear rattle may occur as a transient lash condition during transient drive events such as throttle “tip in”, throttle “tip out”, and rapid clutch disengagement. As is well known, the clutch is disengaged and re-engaged for each ratio interchange and during stopping and launching of the vehicle. Additionally, a countershaft transmission may exhibit gear rattle under steady state drive events, such as when the vehicle is traversing a hill in gear. The gear rattle, in this case, is caused by engine generated torque oscillations within the driveline.

Modern vehicular drivelines may have a number of additional components that may also include meshing gear sets that may be subject to gear rattle. These may include transaxles, transfer cases, and differentials.

Attempts have been made to attenuate gear rattle. These include various bearing designs, component designs, and gear designs to name a few. Each of these attempts may result in increased drag on the shafts to which the gear is mounted, which may be continuously present. This inherent drag may reduce the mechanical efficiency of the system.

### SUMMARY OF THE INVENTION

The damping apparatus of the present invention includes a damper housing disposed about a portion of a rotatable shaft. A variable viscosity fluid, such as a magneto-rheological fluid, is disposed within the damper housing and is operatively associated with the rotatable shaft. A control device is operatively connected to the variable viscosity fluid. The control device is configured or controllable to control the viscosity of the variable viscosity fluid and correspondingly control the amount of rotational resistance applied to the rotatable shaft.

A preferred method for damping a rotatable shaft includes providing a variable viscosity fluid, such as a magneto-rheological fluid, disposed in contact with the rotatable shaft. Thereafter, a variable strength magnet field is preferably generated within the variable viscosity fluid to alter the viscosity thereof. The strength of the magnetic field is controlled to selectively alter the viscosity of the variable viscosity fluid such that the amount of rotational resistance applied to the rotatable shaft is variable.

According to one aspect of the invention, the damping apparatus includes a magnetic device operatively connected to the control device, wherein the magnetic device is configured or controllable to produce a variable strength magnetic fluid within the variable viscosity fluid and thereby selectively alter the viscosity thereof.

According to another aspect of the invention, the damping apparatus includes a fin mounted to the rotatable shaft configured to increase the drag transferred to the rotatable shaft when engaged by the variable viscosity fluid.

According to yet another aspect of the invention, the damping apparatus includes a seal disposed within a seal groove defined by the damper housing.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross-sectional view of a powertrain including a damper assembly in accordance with the present invention; and

FIG. 2 is a schematic cross-sectional view of a damper assembly of the powertrain of FIG. 1.

### DESCRIPTION OF THE PREFERRED EMBODIMENTS

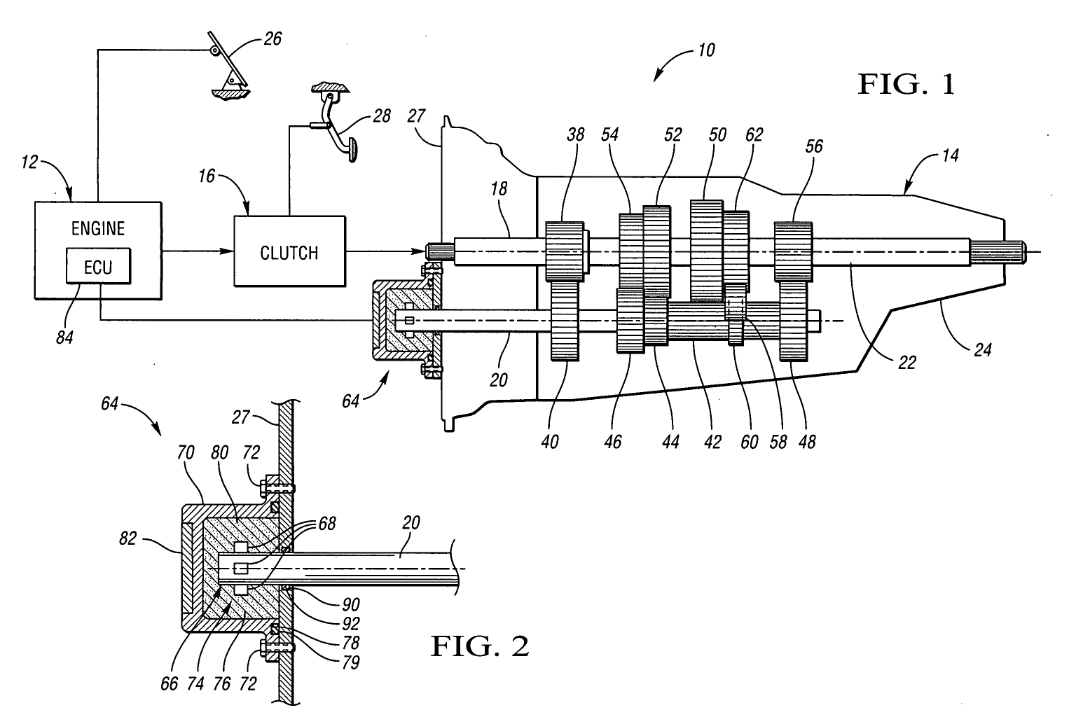

Referring to the drawings, wherein like reference numbers refer to like components, FIG. 1 shows a powertrain 10 including an engine 12, a countershaft transmission 14, and a manually operated clutch assembly 16 operatively connected therebetween. The countershaft transmission 14 is shown for illustrative purposes, and it should be appreciated that the present invention may also be applied to alternate applications that incorporate a rotatable shaft. The transmission 14 includes a transmission housing 24 having a front cover 27 mounted thereto. The transmission 14 also includes an input shaft 18, a countershaft 20, and an output shaft 22 that are at least partially disposed within the housing 24. The input shaft 18 is coaxially aligned with the output shaft 22, and the countershaft 20 is in parallel relation with both the input shaft 18 and the output shaft 22. The engine 12 has a throttle control 26 and the clutch assembly 16 has a clutch control 28. Both of the controls 26 and 28 are manually operated by the operator. When the clutch 16 is engaged, the engine 12 will rotate the input shaft 18.

The input shaft 18 has a head gear 38 drivingly connected thereto and meshing with a head gear 40 that is drivingly connected with the countershaft 20 such that the countershaft 20 will rotate whenever the input shaft 18 is rotating. The countershaft 20 has a plurality of speed or ratio gears 42, 44, 46, and 48 drivingly connected therewith and meshing with respective speed or ratio gears 50, 52, 54 and 56 that are disposed on the output shaft 22. A reverse idler 58 is rotatably mounted on an idler shaft (not shown), and is meshing with a ratio gear 60 on the countershaft 20 and a ratio gear 62 on the output shaft 22. Each of the ratio gears 50, 52, 54, 56, and 62 are selectively individually connectable with the output shaft 22 by respective synchronizers, not shown, of conventional design. A selectively actuatable damper assembly 64 is mounted to the front cover 27 as will be described in detail hereinafter.

When the operator wishes to change the speed ratio between the input shaft 18 and the output shaft 22, the throttle control 26 is released and clutch mechanism is 28 is actuated by the operator. The operator then manually, through a conventional shift control linkage (not shown), manipulates the synchronizers to release one ratio and engage the other. This operation is well-known. Also during vehicle deceleration, the operator releases the throttle control 26 to permit the engine to reduce in speed thereby slowing the vehicle. The throttle release is also known as “tip out”.

It is well known to apply drag to one or more of the input shaft 18, the countershaft 20, and/or the output shaft 22 in an attempt to slow the relative speed of meshing gears and thereby reduce gear noise. These attempts include various bearing designs, component designs, and gear designs. It has been observed, however, that this additional drag may reduce the mechanical efficiency of the system. Advantageously and in accord with this invention, the damper assembly 64 is selectively actuatable or operable such that it may be implemented when there is an increased likelihood of gear noise, such as, for example, during transient drive events including throttle “tip in”, throttle “tip out”, or rapid clutch disengagement; and thereafter the damper assembly 64 may be deactivated to improve the mechanical efficiency of the system.

Referring to FIG. 2, the damper assembly 64 is shown in more detail. To facilitate engagement with the damper assembly 64, an end portion 66 of the countershaft 20 is extended through the front cover 27 and out of the transmission housing 24. The damper assembly 64 includes a damper housing 70 circumscribing the end portion 66 of the countershaft 20 and is mounted to the front cover 27 such as with the threaded fasteners 72. When mounted to the front cover 27, the damper housing 70 defines a reservoir or cavity 74 that is filled with a controlled volume of variable viscosity fluid 76. The damper housing 70 preferably also defines a seal groove 78 adapted to accommodate an O-ring seal 79 and thereby seal the interface between the front cover 27 and the damper housing 70 such that the variable viscosity fluid 76 does not leak out of the reservoir 74. Similarly, the front cover 27 preferably defines a seal groove 90 adapted to accommodate a seal 92 and thereby seal the interface between the front cover 27 and the countershaft 20 such that the variable viscosity fluid 76 does not leak out of the reservoir 74.

In the preferred embodiment, the variable viscosity fluid 76 is a magneto-rheological (MR) fluid 80; however alternate fluids such as, for example, electro-rheological fluid may also be envisioned. The MR fluid 80 has a dense suspension of micrometer-sized particles in a liquid that will cause the MR fluid 80 to solidify into a pasty consistency of high viscosity in the presence of a magnetic field, and re-liquefy upon removal of the field. Accordingly, the damper assembly 64 preferably includes a magnetic device or source 82 retained by the damper housing 70. The magnetic device 82 is configured to selectively produce a magnetic field within the MR fluid 80 to control the viscosity thereof. The magnetic device 82 is connected electrically with a control device such as an electronic control unit (ECU) 84 (shown in FIG. 1) that controls engine performance and has a plurality of sensors that include a throttle position sensor, a clutch actuator sensor, and input and output speed sensors. The ECU 84 preferably includes a programmable digital computer that issues commands to the powertrain 10 (shown in FIG. 1).

The ECU 84 (shown in FIG. 1) is selectively programmable to command the magnetic device 82 to produce a variable strength magnetic field. By varying the strength of the magnetic field, the viscosity of the MR fluid 80 is correspondingly variable. As the viscosity of the MR fluid 80 is increased, the end portion 66 of the countershaft 20 encounters greater rotational resistance such that drag is applied to the countershaft 20. The drag applied to the countershaft 20 resists relative motion between the input shaft 18, the countershaft 20 and the output shaft 22 such that gear noise is minimized. The ECU 84 preferably activates or energizes the magnetic device 82 only when there is an increased likelihood of gear noise, such as, for example, during transient drive events including throttle “tip in”, throttle “tip out”, or rapid clutch disengagement; and thereafter the magnetic device 82 is deactivated reduce countershaft 20 resistance and improve the mechanical efficiency of the system. The normal state of the magnetic device 82 is preferably “off” or “low” so that vehicle performance and fuel economy are not unnecessarily diminished.

According to a preferred embodiment, the end portion 66 of the countershaft 20 includes a plurality of fins 68 configured to increase drag transferred to the countershaft 20 when engaged by the MR fluid 80. In some applications; however, the MR fluid 80 can transfer enough drag directly to the end portion 66 of the countershaft 20 so that the fins 68 are not required. According to alternate embodiments, the fins 68 may be formed onto a separate attachment or extension (not shown) that is mounted to a conventional countershaft.

While the best modes for carrying out the invention have been described in detail, those familiar with the art to which this invention relates will recognize various alternative designs and embodiments for practicing the invention within the scope of the appended claims.

1. A damping system for a rotatable shaft, said damping system comprising:
a damper housing disposed about a portion of the rotatable shaft;
a variable viscosity fluid disposed within said damper housing operatively associated with the rotatable shaft; and
a control device operatively connected with respect to said variable viscosity fluid, said control device being operable to control the viscosity of said variable viscosity fluid and correspondingly control the amount of rotational resistance applied to the rotatable shaft.

2. The damping system of claim 1, wherein said variable viscosity fluid is magneto-rheological fluid.

3. The damping system of claim 1, wherein said variable viscosity fluid is electro-rheological fluid.

4. The damping system of claim 2, further comprising a magnetic device operatively connected to the control device, said magnetic device being configured to produce a variable strength magnetic field within the magneto-rheological fluid and thereby selectively alter the viscosity thereof.

5. The damping system of claim 1, further comprising a fin mounted to the rotatable shaft configured to increase the drag transferred to the rotatable shaft when contacted by the variable viscosity fluid.

6. The damping system of claim 1, further comprising a seal disposed within a seal groove defined by said damper housing, said seal being configured to prevent the loss of the variable viscosity fluid within the damper housing.

7. The damping system of claim 1, wherein said rotatable shaft is a countershaft.

8. A damping system for a transmission having a rotatable shaft, said damping system comprising:
a damper housing disposed about a portion of the rotatable shaft;
magneto-rheological fluid disposed within said damper housing and operatively associated with the rotatable shaft;
a magnetic device disposed in close proximity with respect to said magneto-rheological fluid, said magnetic device being operable to selectively produce a variable strength magnetic field within the magneto-rheological fluid to alter the viscosity thereof; and
a control device operatively connected to the magnetic device, said control device being operable to control the strength of the magnetic field produced by the magnetic device to thereby control the viscosity of the magneto-rheological fluid such that the amount of rotational resistance applied to the rotatable shaft is variable.

9. The damping system of claim 8, further comprising a fin mounted to the rotatable shaft configured to increase the drag transferred to the rotatable shaft when engaged by the magneto-rheological fluid.

10. The damping system of claim 9, further comprising a seal disposed within a seal groove defined by said damper housing, said seal being configured to prevent the loss of the variable viscosity fluid within the damper housing.

11. The damping system of claim 10, wherein said rotatable shaft is a countershaft.

12. A method for damping a rotatable shaft of a transmission comprising:
providing a magneto-rheological fluid operatively associated with said rotatable shaft;
generating a variable strength magnetic field within the magneto-rheological fluid to alter the viscosity thereof; and
controlling the strength of the magnetic field to selectively alter the viscosity of the magneto-rheological fluid such that the amount of rotational resistance applied to the rotatable shaft is variable.

13. The method of claim 12, further comprising providing a damper housing to retain the magneto-rheological fluid in contact with the rotatable shaft.

14. The method of claim 13, further comprising providing a fin mounted to the rotatable shaft configured to increase the drag transferred to the rotatable shaft when engaged by the magneto-rheological fluid.
